(19) United States
(12) Patent Application Publication
(10) Pub. No.: US 2009/0327393 A1
(43) Pub. Date: Dec. 31, 2009

(54) NETWORK AGGREGATION

(76) Inventors: Xintian E. Lin, Mountain View, CA (US); Qinghua Li, Sunnyvale, CA (US)

Correspondence Address: SCHWEGMAN, LUNDBERG & WOESSNER, P.A., P.O. BOX 2938, MINNEAPOLIS, MN, 55402, US

(21) Appl. No.: 12/165,288

(22) Filed: Jun. 30, 2008

(51) Int. Cl. G06F 15/16

(52) U.S. Cl. 709/201

(57) ABSTRACT

Disclosed are example embodiments of methods and systems for increasing the bandwidth available to transmit content or data from a source, for example located at a central office or head end, to one or more computing platforms, such as notebook computers, located, for example, but not by way of limitation, on or near subscriber premises. Content is segmented and transmitted to a plurality of computing platforms, each platform receiving at least one different segment, using, for example, a first distribution network such as a digital subscriber loop (DSL) network. Using a second network, such as peer-to-peer wireless connections between the platforms, the platforms exchange the segmented content and reassemble the content to its un-segmented form, so that the distribution capacity of the first network can be aggregated.

### TECHNICAL FIELD

The inventive subject matter relates generally to networks and more particularly to the transfer of data through a network.

### BACKGROUND

Currently, a popular usage model for a computer or computer-based device is to watch high definition (“HD”) video or other content streamed online through a Digital Subscriber Loop (“DSL”) network. The real time streaming rate of HD content is about 12-18 mbps, however, and exceeds the bandwidth of DSL networks, which currently have a bandwidth that ranges up to about 1.5 mbps. Accordingly, it is not possible to stream HD video in real time on a DSL network. Even using higher speed data transmission protocols, such as the Very High Speed Digital Subscriber Line 2 (“VDSL2”) technology, real time streaming of HD content may be possible only for transmission line lengths that are less than about one mile. This barrier currently limits the wide deployment of some high-bandwidth usage models, for example, on demand video and HD real time streaming such as an HD broadcast.

### BRIEF DESCRIPTION OF THE DRAWING

FIGS. 1A and 1B illustrate a first example embodiment of a system and method for network aggregation, according to the inventive subject matter.

FIG. 2 illustrates another example embodiment of a system and method for network aggregation, according to the inventive subject matter.

FIG. 3 illustrates still another example embodiment of a system and method for network aggregation, according to the inventive subject matter.

FIG. 4 illustrates an example embodiment of a computer system, according to the inventive subject matter.

### DETAILED DESCRIPTION

In the following detailed description of example embodiments of the invention, reference is made to specific example embodiments of the invention by way of drawings and illustrations. These examples are described in sufficient detail to enable those skilled in the art to practice the invention, and serve to illustrate how the invention may be applied to various purposes or embodiments. Other embodiments of the invention exist and are within the scope of the invention, and logical, mechanical, electrical, and other changes may be made without departing from the subject or scope of the present invention. Features or limitations of various embodiments of the invention described herein, however essential to the example embodiments in which they are incorporated, do not limit other embodiments of the invention, or the invention as a whole, and any reference to the invention, its elements, operation, and application do not limit the invention as a whole but serve only to define these example embodiments. The following detailed description does not, therefore, limit the scope of the invention, which is defined only by the appended claims.

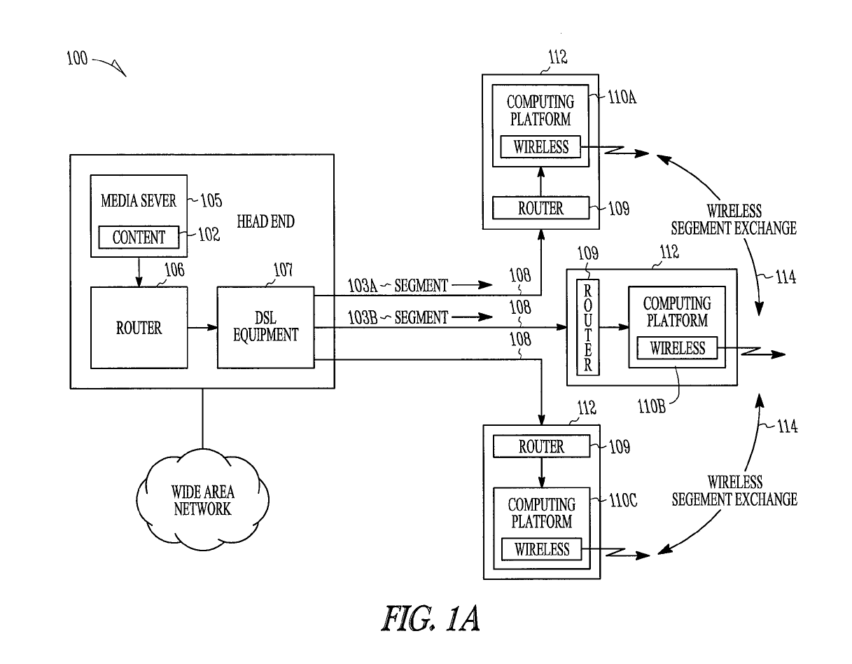

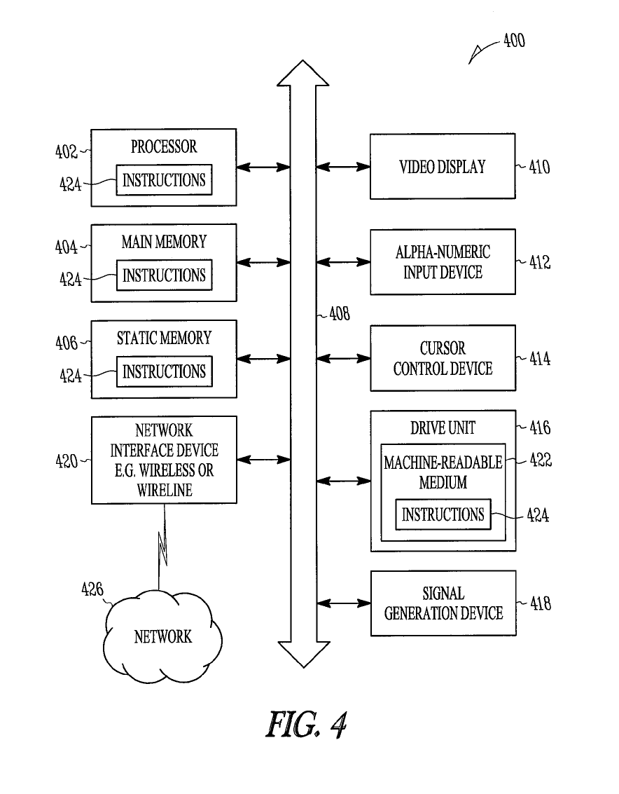

FIGS. 1A and 1B illustrate a first example embodiment 100 of a system and method for network aggregation, according to the inventive subject matter. According to embodiment 100, there is provided method and systems for increasing the bandwidth available to transmit HD content 102, or other data, from a media server 105 located at a central office or head end to one or more computing platforms 110a, 110b and 110c (also referred to as platforms 110) located, for example but not by way of limitation, on or near subscriber premises 112. Platforms 110 may include, but are not limited to, laptop computers, notebook computers, mobile telephone, music/audiovisual players, handheld computers, personal digital assistants (“PDAs”), desktop computer platforms, or any other form of personal computer. An example of a computing platform 110 with wireless capability is described in more detail below with respect to FIG. 4.

According to one example embodiment of the inventive subject matter, content 102 is partitioned into segmented content 103, for example content 103a and 103b, and multiplexed through router 106 and head end DSL equipment 107 to respective platforms 110a and 110b over DSL network connections or path 108. Each platform 110 may receive a different segment of the content 102, and in turn exchange or transmit the segments to other platforms over peer-to-peer wireless paths 114. As shown in FIG. 1B, content segments 103a and 103b are then reassembled at each platform 110 to form all or a portion of the un-segmented content 102 originating from the media server 105. The reassembled content 102 may then be played on the respective platform 110. According to one example embodiment, content segments 103 may be transmitted between any two peers within range of one another, or may be exchanged through one or more intermediary platforms 110. Further, the segmented content 103 may be received in any order and reassembled by the platform 110 in the correct sequence for playback. Still further, content 102 may be segmented in any fashion, for example by portioning each frame, by selecting every other frame, or by forming groups of frames and selecting every other group, or by other schemes.

Accordingly, although neither of the two DSL paths 108 alone supports the required bandwidth for real-time HD content broadcast, the capacity of the two DSL signal paths 108 can be aggregated. In one embodiment, segmentation may provide for one platform 110 receiving the odd rows of an image frame for the HD content 102, and the other platform 110 receiving the even rows. The respective platforms 110 each then transmit to the other platforms 110 the rows they receive, using their wireless capability, and the content sharing is then established between the users. The contents from the DSL paths 108 and wireless paths 114 (for example, but not limited to, a WiFi path) are put into order and aggregated by platforms 110.

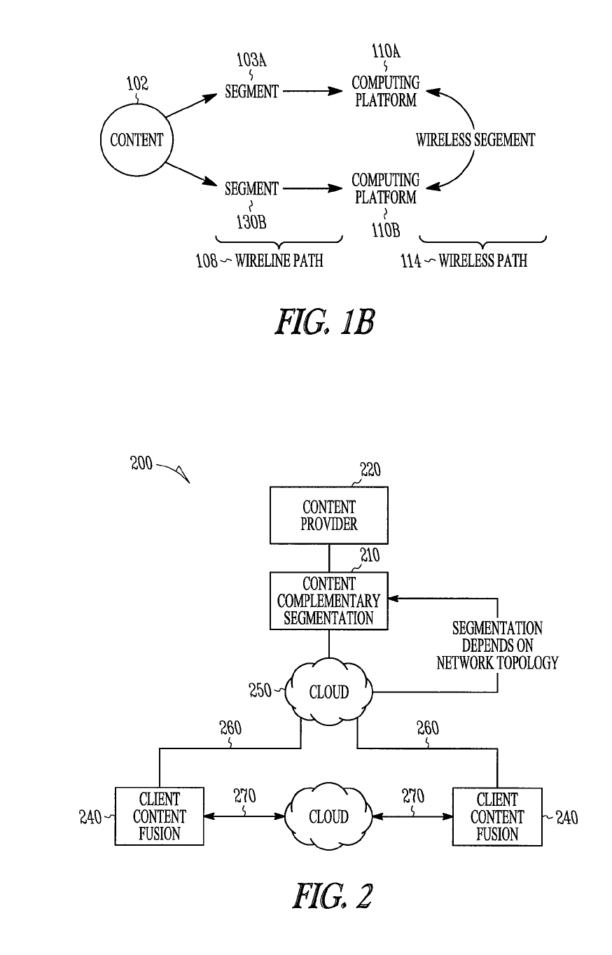

FIG. 2 illustrates another example embodiment of a system and method for network aggregation, according to the inventive subject matter. According to FIG. 2, the network aggregation is handled by Content Complementary Segementation (“CCS”) software 210 on the side of the content provider 220 and a Content Fusion (“CF”) aggregation driver 240 at the client side operative on platforms 110. In the architecture of FIG. 1A, CCS software 210 and CF driver 240 may be operative on media server 105 and platform 110, respectively. As shown in FIG. 2, CCS software 210 segments the content and passes it through network 250 to CF drivers 240 through the primary network paths 260. CF drivers 240 in turn pass segmented content to each other through secondary wireless paths 270. According to one example embodiment of operation, the driver 240 may inform a neighbor(s) platform 110, using the wireless path 270, of a request for HD content made by its host platform 110. The driver 240 of the other platform 110 may then check the content request of the neighbor(s) and make a complementary request, for example for the even row of the frame or the neighbor made a request for the odd row. According to another example embodiment, the segmentation is performed according to the network topology.

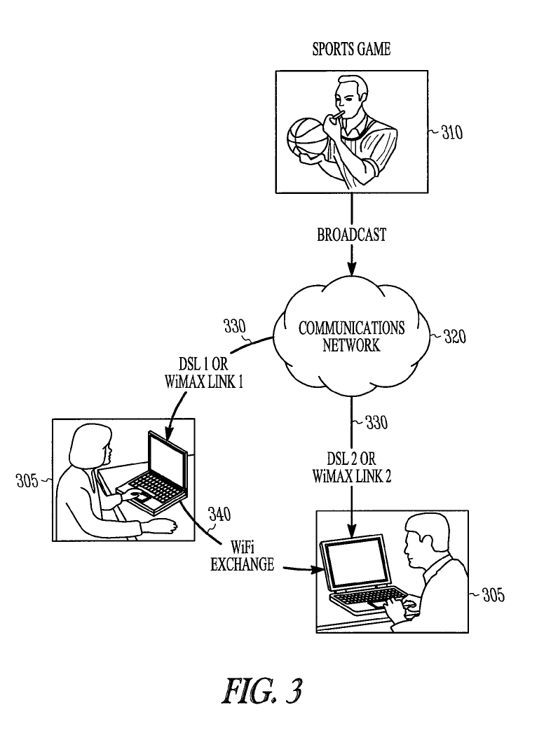

FIG. 3 illustrates still another example embodiment of a system and method for network aggregation, according to the inventive subject matter In this embodiment, similar to that of FIGS. 1A, 1B and 2, each user/platform 305 downloads portions or a segment of the content 310, such as a sports game as illustrated, through a network 320, except instead of downloading a segment over a single network such as a DSL network, the download may take place on multiple heterogeneous network paths, for example a wireline or wireless path 330. Further, in another embodiment, the content may reside on multiple servers and be delivered from multiple different servers or sources. The transport and physical layers of paths 330 may take the form of one or more of Ethernet, WiFi, WiMax, WCDMA, UWB, twisted pair, coax, fiber or any other network type or communication protocol.

As described above, segmented content is exchanged with other users/platforms 305 through a peer-to-peer wireless path 340, which may take the form, for example, of a WiFi connection in any other wireless connection. According to one embodiment of this heterogeneous network aggregation, a routing algorithm, operative at the server and clients, intelligently partitions, coordinates, routes, and reassembles the contents through all available I/O network simultaneously, as for example, in generally the same manner as described above with respect to FIGS. 1A, 1B and 2. Further, the system and method of FIG. 3 may also, in one example embodiment, use the segmentation software and fusion software to provide for segmentation and reconstitution of the content 310.

While illustrated above with the example of download aggregation with two users, the described method and system is extensible to more than two users. Accordingly, with collaboration and aggregation as described herein, users of a DSL network can watch HD content. In many environments, there is an average of 10+WiFi devices in platforms 10 in range of each other. This would allow, for example, diversity and multiplicity, such that the reliability of the scheme can be acceptable. In addition, according to one example embodiment of the inventive subject matter, the path 108 may include any combination of physical transport layer including, but not limited to, twisted pair, coax, fiber, or wireless transport layers. Wireless paths 114 are provided, according to one example embodiment, using wireless communications capabilities deployed in, or in conjunction with, platforms 110, such as but not limited to WiFi capability currently standard on many computing platforms, or any other wireless capability that may be part of or used in conjunction with a computing platform 110.

FIG. 4 illustrates an example embodiment of a computer system 400, according to the inventive subject matter. FIG. 4 shows a diagrammatic representation of machine in the example form of a computer system 400 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 400 includes a processor 402 (e.g., a central processing unit (CPU), a graphics processing unit (GPU), or both), a main memory 404 and a static memory 406, which communicate with each other via a bus 408. The computer system 400 may further include a video display unit 410 (e.g., a liquid crystal display (LCD) or a cathode ray tube (CRT)). The computer system 400 also includes an alphanumeric input device 412 (e.g., a keyboard), a user interface (UI) navigation device 414 (e.g., a mouse), a disk drive unit 416, a signal generation device 418 (e.g., a speaker) and a network interface device 420.

The disk drive unit 416 includes a machine-readable medium 422 on which is stored one or more sets of instructions and data structures (e.g., software 424) embodying or utilized by any one or more of the methodologies or functions described herein. The software 424 may also reside, completely or at least partially, within the main memory 404 and/or within the processor 402 during execution thereof by the computer system 400, the main memory 404, and the processor 402 also constituting machine-readable media. The software 424 may further be transmitted or received over a network 426 via the network interface device 420 utilizing any one of a number of well-known transfer protocols (e.g., HTTP).

While the machine-readable medium 422 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention, or that is capable of storing, encoding, or carrying data structures utilized by or associated with such a set of instructions. The term “machine-readable medium” shall accordingly be taken to include, but not be limited to, solid-state memories, optical and magnetic media.

Accordingly, the example embodiments of the inventive subject matter provide a solution to the barrier for high bandwidth applications without high cost network upgrades. Further, the various embodiments of the inventive subject matter exploit the existing wireless radio hardware on various computer platforms increasing throughput for DSL applications without adding hardware cost.

Thus, as described herein, there is provided, according to at least one example embodiment, a system and method of heterogeneous network aggregation using, according to one example embodiment, a peer-to-peer technology that delivers high network bandwidth to computing platforms such as, but not limited to, notebook computers.

1. A system comprising:
a first network to distribute content from a source to a plurality of computing platforms;
the computing platforms connected through a second network, wherein the second network is a wireless network formed using wireless communication capabilities of the computing platforms;
at least one source software program adapted to partition the content into a plurality of segments;
at least one of the computing platforms receiving at least one of the segments and at least one other of the computing platforms receiving at least one other segments;
at least one platform software program operative on the computing platforms receiving one of the segments, wherein the platform software program is adapted to exchange segments between the respective computing platforms and to combine segments on a respective platform to reconstitute the content in its un-segmented form.

2. A method comprising:
at least one source software program adapted to partition content from a source into a plurality of segments;
distributing the segmented content from the source to a plurality of computing platforms using a first network;
at least one of the computing platforms receiving at least one of the segments and at least one other of the computing platforms receiving at least one other segment;
at least one platform software program operative on the computing platforms receiving one of the segments, wherein the platform software program is adapted to exchange segments between the respective computing platforms and to combine segments on a respective platform to reconstitute the content in its un-segmented form; and
the computing platforms exchanging the segmented content through a second network, wherein the second network is a wireless network formed using wireless communication capabilities of the computing platforms.
